(19) United States
(12) Patent Application Publication
(10) Pub. No.: US 2003/0123355 A1
(43) Pub. Date: Jul. 3, 2003

(54) Method for raising success rate of compact disc recording

(76) Inventor: David Hsieh, Taipei (TW)

Correspondence Address: Jason Z. LIN, Supreme Patent Services, Post Office Box 2339, Saratoga, CA, 95070-0339, US

(21) Appl. No.: 10/164,827

(22) Filed: Jun. 6, 2002

(30) Foreign Application Priority Data
Dec. 31, 2001 (TW) 090133556

(51) Int. Cl. G11B 7/00

(52) U.S. Cl. 369/53.2

(57) ABSTRACT

The present invention relates to a method for raising the success rate for compact disc (CD) recording. The method includes (1) obtaining a set of parameters of the type of CD, the set of parameters are fed to the CD burner for the recording setting, and (2) adding the set of parameters to the CD burner for future recording. With present invention, the CD burner can be used to record on CDs from different suppliers for quality results.

### FIELD OF THE INVENTION

This invention relates to a method for compact disc (CD) burners to record on recordable CDs, in particular, to a method for providing CD burners with information for recording on recordable CDs from different suppliers with quality results.

### BACKGROUND OF THE INVENTION

Conventional CD burners are shipped with a pre-stored set of parameter sets. Each parameter set corresponds to the characteristics of a type of CD. Because of the pre-shipping parameter sets of the selected types of CDs, these conventional CD burners usually perform well with the pre-selected CD types. However, when the burner is used to record on CDs of other types, the result is either unable to record or recording with poor quality. This has greatly limited consumers' choices of using other types of CDs. The reason lies in that the conventional CD burner is not capable of adjusting the parameter setting for recording correctly on other types of CDs.

### SUMMARY OF THE INVENTION

The present invention is to provide a method for the CD burners to record on different types of CDs with quality recording. To achieve this goal, the invention provides a method comprising of two steps: first, obtaining the parameter set for the new type of CD. The burner can be pre-set in accordance with the parameters when recording on the new type of CD. Second, the new set of parameters is added to the CD burner so that it can operate well with the CDs of the same type in future recording.

The present invention will become more clear from the following description when taken in connection with the accompanying drawings which show, for purposes of illustration only, a preferred embodiment in accordance with the present invention.

### BRIEF DESCRIPTION OF THE DRAWINGS

FIG. 1 shows the waveform of a CD burner writing into a CD-Recordable disc (CD-R).

FIG. 2 shows the waveform of a CD burner writing into a CD-Rewritable disc (CD-RW).

FIG. 3 shows the flowchart of the present invention.

### DETAILED DESCRIPTION OF THE INVENTION

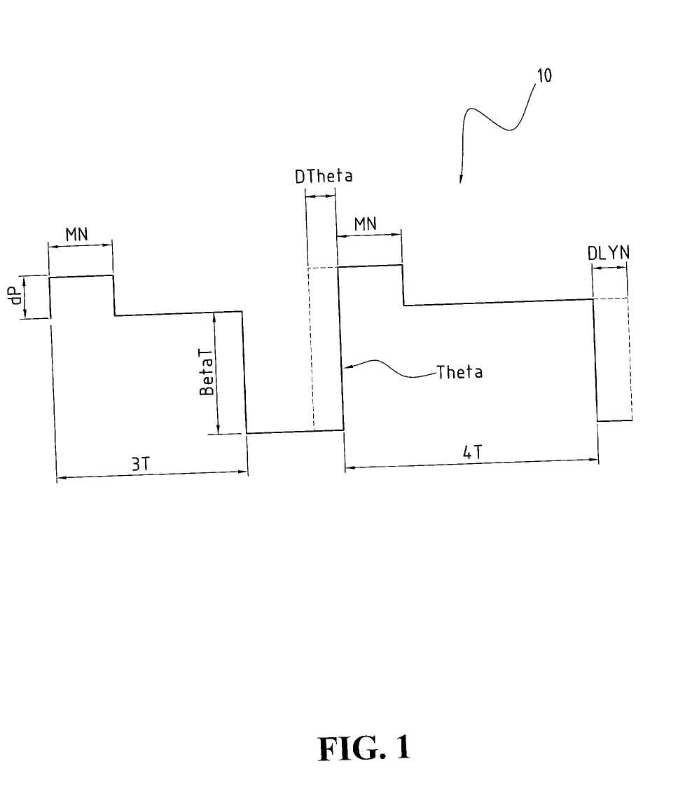

FIG. 1 shows the waveform of writing into a blank CD-Recordable disc (CD-R). Waveform 10 indicates the following parameters: ROPC (Running Optimum Power Control), Theta (displacement distance between 3T-11T, Theta is the initial value of the waveform), dTheta (the width of Theta forward extension), MN (T value of extension power), DLYN (the width of Theta backward extension), BetaT (power used in writing), dp (power used in extension power), Pw (power at the center), D1 (defined as ½*dTheta +½*DLYN), Kp and Lp (amplifying factor). The T value is a time unit, which is about 220 nano-seconds. The Kp and Lp are defined as:

$$\begin{matrix}Kp , Lp = {OPC}_{12 x} * {k}_{16 x} + {L}_{16 x} = {OPC}_{16 x} , or \\ {OPC}_{12 x} * {k}_{20 x} + {L}_{20 x} = {OPC}_{20 x} , or \\ {OPC}_{12 x} * {k}_{24 x} + {L}_{24 x} = {OPC}_{24 x}\end{matrix}$$

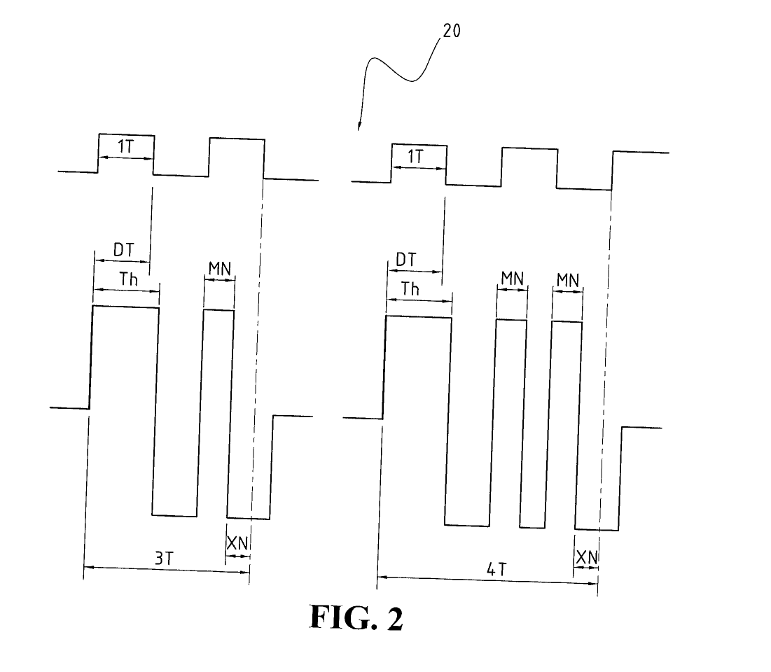

FIG. 2 shows the waveform of writing into a blank CD-Rewritable disc (CD-RW). Waveform 20 includes the following parameters: Pindx (power at the center), roux (power used in writing), epsx (power used in erasing), MN, DT, TH, and XN.

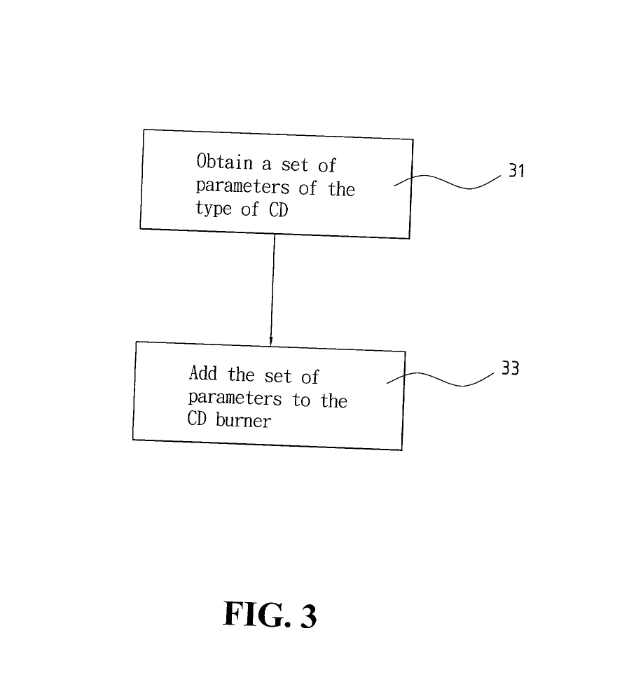

FIG. 3 shows the flowchart of the present invention. Step 31 is to obtain a set of parameters of the type of CD. The CD burner is re-set to these parameters when recording into the blank CD. For example, the set of parameters for recording on the CD-R is shown in FIG. 1, and that for recording on the CD-RW is in FIG. 2. Step 33 is to add the said set of the parameters to the CD burner. Because the CD burner includes some non-volatile semiconductor memory, such as flash memory, step 33 stores the parameter set in the non-volatile memory.

When the CD burner is recording on the CD, the executed firmware program can recognize the maker and the type of the CD currently loaded in According to this information, the CD burner can access the corresponding parameter set for the CD type stored in the non-volatile memory. The CD burner then uses the parameters to adjust the hardware setting when recording on the CD, so that the success rate can be raised.

Furthermore, the manufacturers of the CD burners can also provide the parameter sets for different types of CD on their website for the users to download. This allows the users to have a wider selection of CD for recording.

While we have shown and described the embodiment in accordance with the present invention, it should be clear to those skilled in the art that further embodiments may be made without departing from the scope of the present invention.

What is claimed is:

1. A method for raising success rate of compact disc (CD) recording comprising the steps of:
(a) obtaining a set of parameters of the CD type, wherein the parameters are used to adjust the hardware setting when recording on the type of CD; and
(b) adding the set of parameters to the CD burner.

2. The method claimed in claim 1, wherein the step of obtaining a set of parameters of the CD includes the steps of:
providing the parameter sets of different types of the CDs on websites of manufacturers of the CD burners; and
downloading the parameter sets through Internet by users.

3. The method claimed in claim 1, wherein the CD is a CD-Recordable disc (CD-R).

4. The method claimed in claim 1, wherein the CD is a CD-Rewritable disc (CD-RW).

5. The method claimed in claim 1, wherein the set of parameters includes at least an ROPC (Running Optimum Power Control).

6. The method claimed in claim 1, wherein the set of parameters includes at least a dTheda (the width of Theta forward extension).

7. The method claimed in claim 1, wherein the set of parameters includes at least an MN (T value of extension power).

8. The method claimed in claim 1, wherein the set of parameters includes at least a D1 (defined as ½*dTheta +½*DLYN).

9. The method claimed in claim 1, wherein the set of parameters includes at least a dp (power used in extension power).

10. The method claimed in claim 1, wherein the set of parameters includes at least a Pw (power at the center).

11. The method claimed in claim 1, wherein the set of parameters includes at least a Kp and an Lp (amplifying factor).

12. The method claimed in claim 1, wherein the set of parameters includes at least a Pindx (power at the center).

13. The method claimed in claim 1, wherein the set of parameters includes at least an roux (power used in writing).

14. The method claimed in claim 1, wherein the set of parameters includes at least an espx (power used in erasing).

15. The method claimed in claim 1, wherein the set of parameters includes at least a DT.

16. The method claimed in claim 1, wherein the set of parameters includes at least an MN.

17. The method claimed in claim 1, wherein the set of parameters includes at least a H.

18. The method claimed in claim 1, wherein the set of parameters includes at least an XN.
